(19) United States
(12) Patent Application Publication
(10) Pub. No.: US 2002/0033847 A1
(43) Pub. Date: Mar. 21, 2002

(54) Automatic bookmarks in informaton system

(75) Inventor: Judith F.M. Masthoff, Brighton (GB)

Correspondence Address: Corporate Patent Counsel, U.S Philips Corporation, 580 White Plains Road, Tarrytown, NY, 10591, US

(73) Assignee: Koninklijke Philips Electronics N.V.

(21) Appl. No.: 09/944,303

(22) Filed: Aug. 31, 2001

(30) Foreign Application Priority Data
Sep. 20, 2000 (GB) 0023006.0

(51) Int. Cl. G06F 3/00

(52) U.S. Cl. 345/776

(57) ABSTRACT

Web bookmarks are automatically put into sets depending on whether web sites are accessed within the same very short time span (e.g. sequentially); are revisited within the same time span (e.g. are both accessed on subsequent visits); or contain data similar to data indicated by an existing bookmark within a set.

This invention relates to automatic bookmarks provided in an information system, that is to say a system in which a structured link to a previously selected location in an information database is stored and subsequently generated automatically for a user. In this specification the term “information database” and the like includes the World Wide Web (www).

To allow fast and easy access to different parts of a large database such as the www, programs such as web browsers enable users to maintain their own links to information elements or sources. The links are known as bookmarks or favourites; in this specification the term bookmark is used to indicate such a structured link.

When a user sees a web page likely to be revisited, a link can be created. Sets of links can be organised in a hierarchical way, and subsets can be organised, the subsets often being termed “folders”. Subsets of subsets may be required. For example, an individuals collection may include a subset called “travel”, which may have a subset called “Europe” which may in turn have a subset called “France”.

Such links are useful, and users tend to generate them in large numbers. Organisation of the links or bookmarks then becomes important to allow fast access to the information.

Many users find it difficult and time consuming to maintain a good organisation of their bookmarks, and tend to have large subsets, perhaps of not-yet-categorised links. Some links could conveniently be classified in more than one subset, but are not.

If the information is to be accessed in a mobile context, e.g. from a Personal Data Assistant or a mobile telephone, when the available display size is limited, short lists requiring limited or no scrolling are highly preferable. Short lists require thorough, deep level structuring of bookmarks. The same requirement applies to eyes-free retrieval, when a list is provided audibly.

One arrangement for providing classification of bookmarks automatically is described in “PowerBookmarks: a system for personalizable Web information organization, sharing and management” by Wen-Syan Li et al, Computer Networks 31 (1999) pages 1375-1389. Bookmarks are automatically classified into folders based on the similarity of the contents, such as key words selected by word frequency analysis; the folders are automatically split or merged to maintain a structure that is easy to navigate; the folders are automatically named and are automatically ranked in a folder depending on the general popularity and access frequency information. A “hot links” folder is automatically maintained of the most popular bookmarks.

Overall, the classification and arrangement of the bookmarks depend on a general structure and not on a personal structure. Individual users have a personalised service only to the extent that a bookmark is added to an individual list only when, by monitoring the user's access pattern, it is found that the user has accessed that link at a higher frequency within a specified time scale than a threshold frequency; however, classification depends on general patterns of use of the database. Individual users are also provided with display preferences.

An object of the invention is to provide a bookmarking system which provides a higher level of tailoring to the requirements of an individual user.

A further object of the invention is to provide a bookmarking system which is not based on the data content of the data site which is accessed.

According to a first aspect of the invention there is provided a method of providing at least one set of bookmarks, each bookmark indicating access to a location in a database, wherein each bookmark in a set is selected on the basis of a criterion different from the content of the data at that location. Preferably. but not essentially, the criterion is a time-based criterion, which may be that the locations are accessed within the same pre-determined time span. In alternative arrangements, the time-based criterion may be the first date of storage of data from the locations, or it may be that the locations are revisited within a predetermined time span.

Within the automated arrangement, it is preferably supported for a user to accept or reject the set of bookmarks.

Also in accordance with the present invention there is provided a personal data processing device comprising means to connect to a remote database, the personal data processing device having automatic means to provide at least one set of bookmarks, each bookmark indicating access to a location in the database, the bookmarks in a set being selected on a criterion different from the content of the data at the location.

The invention will now be described by way of example only with reference to the accompanying drawings in which:

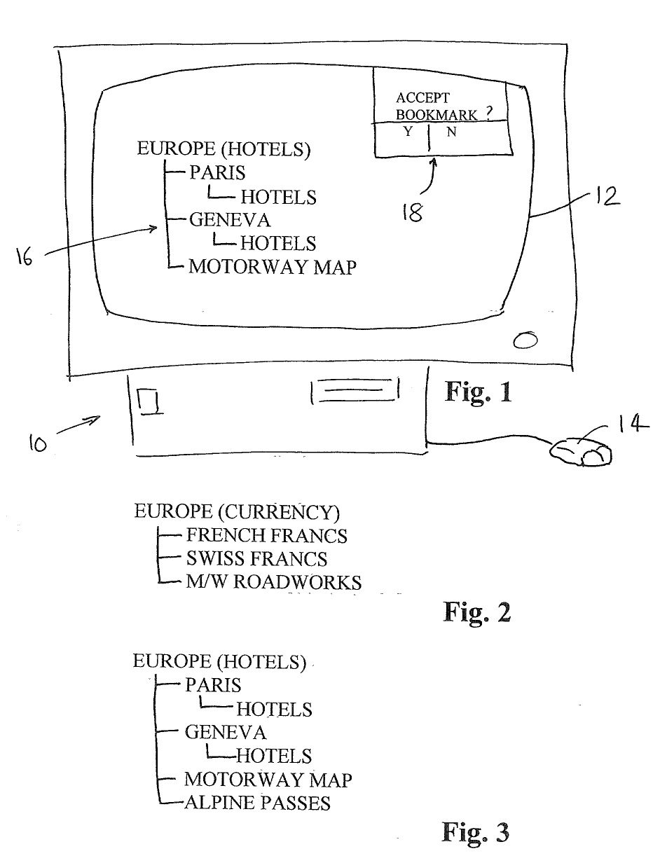

FIG. 1 represents a data processing device embodying the present invention and hosting a first set of bookmarks;

FIG. 2 illustrates a second set of bookmarks; and

FIG. 3 illustrates a modification of the first set.

The bookmark organisation system according to the invention will now be described in the embodiment of a software feature loaded into a conventional personal computer 10, as shown in FIG. 1, with a display screen 12 and a mouse 14, although any programmable data processing device with Internet access capability may host the system.

Suppose the user of the PC accesses the Web to assist in planning a European holiday. The user plans to visit the cities of Paris and Geneva and, as part of their planning, accesses respective web sites for both cities, and stores general information and hotel information. The user is planning to drive to the cities and also accesses and stores a motorway map of Europe.

In conventional bookmark classification systems, the fact that Paris and Geneva are in different countries may result in the country names being included in an automatic classification system, adding an extra subset. In contrast, the inventive classification system recognises that the two cities were accessed within the same short time span, and adds both to a simple menu. Further, the motorway map was accessed within the same short time span and is added also, although it is a different type of information to the city information.

The classification system offered is illustrated in FIG. 1. If the user wishes to accept the classification, the button “Yes” is actuated.

Closer to the date of travel, the user also accesses the web at intervals, seeking information on motorway roadworks and currency exchange rates. Since the user will eventually store only the latest position, but wishes to review the situation, the user does not store the information but merely reads it. However, the inventive bookmark classification system recognises that the two sites accessed at the same time, although being quite different in nature, are likely to be related and of importance, and after a small number of the dual accesses offers a bookmark classification system as in FIG. 2. The user has the option of accepting or rejecting the proposal.

At a different stage in the plans, the user decides to travel from Switzerland into Italy, and accesses a list of opening dates of mountain road passes in the Alps. The inventive bookmark classification system recognises this as similar in type (road travel information) to the European motorway map information, and offers to add a bookmark to the mountain pass information to the same subset as that containing the motorway information, as in FIG. 3.

The classification system can also put the same bookmark into two subsets. For example the motorway roadworks bookmark could be placed in the subset of FIG. 2 and also in the subset of FIG. 1.

By use of the inventive arrangement, deep classification of bookmarks closely tailored to a user's needs is automatically provided for acceptance or rejection by a user. The lists provided are short, and can therefore be conveniently accessed by a portable device having a limited screen display area.

1. A method of providing at least one set of bookmarks, each bookmark indicating access to a location in a database, characterised in that each bookmark in a set is selected on a criterion different from the content of the data at the location.

2. A method according to claim 1, in which the criterion is a time-based criterion.

3. A method according to claim 2, in which the time-based criterion is that the locations are accessed within the same pre-determined time span.

4. A method according to claim 2, in which the time-based criterion is the first date of storage of data from the locations.

5. A method according to claim 2, in which the time-based criterion is that the locations are revisited within a predetermined time span.

6. A method according to claim 1, further comprising allowing a user to accept or reject the set of bookmarks.

7. A personal data processing device comprising means to connect to a remote database, the personal data processing device having automatic means to provide at least one set of bookmarks, each bookmark indicating access to a location in the database, the bookmarks in a set being selected on a criterion different from the content of the data at the location.

8. A personal data processing device according to claim 7, having means to allow a user to accept or reject the automatically offered set of bookmarks.
